(19) United States
(12) Patent Application Publication
(10) Pub. No.: US 2010/0240568 A1
(43) Pub. Date: Sep. 23, 2010

(54) Textile Pretreatment Agent having Gel Comprising Active Agent

(76) Inventors: Peter Schmiedel, Dusseldorf (DE); Matthias Sunder, Dusseldorf (DE); Matthias Uwe Blana, Kaarst (DE)

Correspondence Address: Henkel Corporation, 10 Finderne Avenue, Suite B, Bridgewater, NJ, 08807, US

(21) Appl. No.: 12/794,869

(22) Filed: Jun. 7, 2010

Related U.S. Application Data
(63) Continuation of application No. PCT/EP08/66706, filed on Dec. 3, 2008.

(30) Foreign Application Priority Data
Dec. 7, 2007 (DE) 102007059295.9

(51) Int. Cl. C11D 17/00

(52) U.S. Cl. 510/282

(57) ABSTRACT

Textile pretreatment agent comprising at least two water-insoluble layers connected to each other, a gel comprising active agent being disposed there between in a manner sealed against water vapor. The gel comprising active agent bonds more strongly to a textile web material than to the water-insoluble layers and can thus be applied to a stain easily and without undesired skin contact.

### CROSS REFERENCE TO RELATED APPLICATIONS

The present application is a continuation of International Application No. PCT/EP2008/066706 filed 3 Dec. 2008, which claims priority to German Patent Application No. 10 2007 059 295.9 filed 7 Dec. 2007.

The invention relates to a textile pretreatment agent comprising at least two water-insoluble layers between which a gel containing an active agent is positioned. The invention also relates to a method for preparing such a textile pretreatment agent and the use thereof.

When textiles are cleaned, for example, in a washing machine, not all stains are always completely removed. This can be due, for example, to the type of stains or to the incorrect treatment of the stains. In many cases it is convenient to pretreat the stains with products containing bleach or surfactants.

Such products are commercially available. These products can, for example, be sprayed on, poured onto the stain in liquid form or brushed on with brushes attached to the packaging. Conventional washing agents in liquid or gel form are likewise suitable as stain pretreatment products.

With sprays, the user is exposed to a mist of spray. Regarding products in liquid or gel form, the product can be spilled or the user can use too much, causing the user to come into undesired skin contact with the liquid product.

In addition, with conventional stain pretreatment products pretreatment must take place contemporaneously with the washing process. This requires the consumer to search through dirty laundry for stained textiles, find the stain thereon and pretreat the stains prior to washing the laundry. Such a procedure can be perceived as inconvenient.

Laundry pretreatment agents are known from WO 03/054134 A1, which describes an agent comprising a two-dimensional water-soluble backing and a gel body inseparably attached thereto. This gel body can be brought into contact with a stain for the treatment thereof. Here the gel body is affixed to the textile with the backing—similarly to the principle of a plaster. To prevent the backing from being damaged by water present in the gel body, a barrier layer must be applied between the gel body and the backing, which can lead to residues in the laundry and the washing machine. This barrier layer also increases production effort and costs.

The present invention therefore seeks to provide a textile pretreatment agent which is easy and safe to handle and leaves behind no residues.

This is achieved by textile pretreatment agents having at least two water-insoluble layers, between which an active-agent-containing gel is positioned. The water-insoluble layers are joined together at their edges in such a way that the active-agent-containing gel is at least partially or wholly protected against penetration and/or escape of water vapor. The active-agent-containing gel adheres more strongly to a textile fabric than to the water-insoluble layers.

Such a textile treatment agent can be easily placed on a stain by a user, with minimal or no risk of coming into undesired, direct contact (skin contact or inhalation of an aerosol) with the active cleaning agent, here the active-agent-containing gel. The textile pretreatment agent can be applied to a textile immediately after wearing the garment and discovering a stain and can remain upon it for a time period until it is washed, without the user having to bother with any further textile pretreatment. Furthermore, after having been applied to the textile fabric, the textile pretreatment agent contains no ingredients such as a barrier layer made from a water-insoluble material which would leave residues behind after the washing process.

Preferably, the at least two water-insoluble layers are formed from at least two water-insoluble films.

Before the active-agent-containing gel can be applied to a stain, it must be removed from the water-vapor-proof packaging in such a way that it is on a two-dimensional backing layer, whereby it can be placed on the stain. Through the use of two water-insoluble films, slight inhomogeneities on the surfaces of the water-insoluble films can cause the active-agent-containing gel to adhere more strongly to one of the two water-insoluble films. In this case the water-insoluble film to which the gel adheres serves as the backing layer for the active-agent-containing gel.

In this embodiment it can be particularly preferable for the at least two water-insoluble films surrounding the active-agent-containing gel to differ (e.g., modified as noted below), thus increasing the probability that the active-agent-containing gel will remain on a particular one of the two water-insoluble films.

It can be further preferable for the active-agent-containing gel to adhere more strongly to a first water-insoluble film than to a second water-insoluble film.

With this embodiment the probability is still further increased that the active-agent-containing gel will remain on a particular one of the two water-insoluble films.

In a preferred embodiment a surface facing the active-agent-containing gel of at least one water-insoluble film has been at least partially modified by application of an adhesive layer, application of a layer which repels the active-agent-containing gel, plasma treatment, flame treatment and/or corona treatment.

By means of this method at least one surface of the at least two water-insoluble films can be at least partially modified in a simple manner such that the active-agent-containing gel adheres more strongly or more weakly to this surface.

In another embodiment it is preferable for the at least two water-insoluble layers to be formed from one water-insoluble film.

In this embodiment the water-insoluble film is bent or folded in such a way that the active-agent-containing gel is sandwiched between them. After they are unfolded, a backing layer with the active-agent-containing gel adhering thereto is automatically obtained.

It can be preferable for at least one water-insoluble layer to contain a recess, so that a sufficient amount of active-agent-containing gel can be introduced between the water-insoluble layers.

It is further preferable for the active-agent-containing gel to have a water-soluble or water-dispersible gel matrix. With the aid of a water-soluble or water-dispersible gel matrix, an active-agent-containing gel having a high minimum strength is obtained which is simple to produce and/or is simple to load with active agents.

In order for it to form the gel matrix it is advantageous for the active-agent-containing gel to include a crosslinked polymer, a liquid crystalline phase, inorganic particles and mixtures thereof.

It is preferable for the active-agent-containing gel to include an active agent selected from the group including surfactants, bleaching agents, bleach catalysts, enzymes, organic solvents, acids, alkalis, complexing agents and mixtures thereof.

These active agents are particularly suitable for the removal, minimization and/or partial dissolution of stains on a textile fabric.

In a preferred embodiment of the invention the active-agent-containing gel contains a surfactant and/or hydrogen peroxide or a source thereof.

Most stains on textile fabrics can be removed, minimized or partially dissolved in this way. For example, many of the stains which are not (completely) removed in a conventional domestic washing and cleaning process in a washing machine are bleachable stains. The stains can be made less visible with the aid of a textile pretreatment agent containing hydrogen peroxide. Further advantages of hydrogen peroxide are that it can be incorporated particularly easily into an active-agent-containing gel, is an inexpensive bleaching agent and leaves no residues on the textiles treated therewith.

Furthermore, it is advantageous for the aesthetics, production and/or handling of the textile pretreatment agent for the active-agent-containing gel to include a further ingredient selected from the group including humectants, gel breakers, dyes, fragrances, adhesion enhancers and mixtures thereof.

The present invention also relates to the use of a textile pretreatment agent according to the invention for the removal, minimization and/or partial dissolution of stains on a textile fabric.

Furthermore, a method is disclosed for producing a textile pretreatment agent comprising at least two water-insoluble layers, between which an active-agent-containing gel is positioned, the active-agent-containing gel adhering more strongly to a textile fabric than to the water-insoluble layers, the water-insoluble layers being joined together at their edges in such a way that the active-agent-containing gel is largely protected against the penetration and/or escape of water vapor.

The invention is described in more detail below by reference inter alia to the examples.

A textile pretreatment agent according to the invention comprises an active-agent-containing gel and at least two water-insoluble layers, the active-agent-containing gel being positioned between the water-insoluble layers in such a way that it is impervious to water vapor.

Within the context of this application a gel is understood firstly to be a finely dispersed system consisting of at least one solid and one liquid phase. The solid phase forms a sponge-like, three-dimensional network (gel matrix), the pores of which are filled with a liquid (lyogel). The two phases are completely interpenetrated (bicoherent).

Within the context of this invention the term gel also refers to liquid systems having a very high viscosity, preferably with a yield point, which do not flow or run without an additional external action.

The active-agent-containing gel preferably has a gel matrix loaded with the active agent in pure form or in the form of a solution. In a preferred embodiment this gel matrix is completely water-soluble. The gel matrix can be formed, for example, by a hydrogel, a reversibly crosslinkable polymer and/or inorganic particles.

Within the context of this application a hydrogel is understood to be a hydrophilic polymer or polymer blend which is made water-insoluble by moderate crosslinking and which has a rubber-like consistency. Crosslinking is brought about by suitable crosslinking agents that produce covalent bonds between the polymer chains. Suitable hydrophilic polymers are natural polymers such as polysaccharides, proteins or synthetic polymers. Suitable polysaccharides include alginates, guar, starch and cellulose and derivatives thereof. Suitable proteins include gelatin. Polyvinyl alcohols, polyvinyl pyrrolidones, polyacrylates or copolymers thereof are suitable for example as synthetic polymers. As crosslinking of the hydrophilic polymers is largely irreversible and the gel matrix does not dissolve completely during the washing process, it is advantageous to remove the gel matrix before the actual washing process.

It is therefore more preferable that the gel matrix be at least dispersible in the washing liquor but preferably soluble as far as possible in the washing liquor. This can be achieved through the use of reversibly crosslinkable polymers. Such reversible crosslinkages can be achieved, for example, through ionotropic crosslinking of suitable polymers with divalent ions. Various polymers which have been reversibly crosslinked by calcium or magnesium ions are insoluble in pure water but dissolve in conventional washing liquor during the washing process, particularly under the mechanical conditions arising therein.

Polymers which can be crosslinked ionotropically include natural polymers such as alginates, pectins or cellulose (derivatives), as well as synthetic polymers such as polyvinyl alcohols or acrylates. Preferred ions for crosslinking are calcium and/or magnesium ions.

A gel matrix can also be produced with inorganic particles such as silicas, silicates and/or clays. Suitable clay is smectite clay, for example. Preferred smectite clays are beidellite clays, hectorite clays, laponite clays, montmorillonite clays, nontronite clays, saponite clays, sauconite clays and mixtures thereof. Montmorillonite clays are gel-matrix-forming clays. Bentonites contain predominantly montmorillonites and can serve as a preferred source for gel-matrix-forming clay.

Loading of the gel matrix with the active agent can take place in various ways. For a simple, sponge-like gel matrix, loading can occur by dipping, spraying or applying the pure active agent or a solution, emulsion or dispersion of the active agent. If a crosslinkable polymer is used, formation of the gel matrix can also take place directly in a solution containing the active agent(s). To this end a solution is first produced containing the active agent, crosslinkable polymer and any further ingredients, wherein the solution is initially still free-flowing. This solution is mixed, covered or otherwise brought into contact with the crosslinking agent. The degree of crosslinking and hence the release kinetics of the active agent can be influenced by crosslinking agent concentration and the length of contact time. In order to establish the ideal consistency in the active-agent-containing gel obtained, said gel can undergo a drying stage in which part of the water contained within it is removed.

The active-agent-containing gel preferably contains an active agent chosen from surfactants, bleaching agents, bleach catalysts, enzymes, hydrocarbons and mixtures thereof.

Anionic, non-ionic, cationic, zwitterionic and/or amphoteric surfactants can be used as surfactant(s). From an application-oriented perspective, non-ionic surfactants, anionic surfactants and mixtures of anionic and non-ionic surfactants are preferred.

Alkoxylated, advantageously ethoxylated, particularly primary alcohols having preferably 8 to 18 C atoms and on average 1 to 12 mol of ethylene oxide (EO) per mol of alcohol are preferably used as non-ionic surfactants, in which the alcohol residue can be linear or preferably methyl-branched in the 2-position or can contain linear and methyl-branched residues in the mixture, such as are conventionally present in oxoalcohol residues. However, alcohol ethoxylates having linear residues obtained from alcohols of native origin having 12 to 18 C atoms, for example, from coconut, palm, tallow or oleyl alcohol, and on average 2 to 8 EO per mol of alcohol are particularly preferred. The preferred ethoxylated alcohols include, for example, C₁₂₋₁₄ alcohols having 3 BO, 4 EO or 7 EO, C₉₋₁₁ alcohol having 7 EO, C₁₃₋₁₅ alcohols having 3 EO, 5 EO, 7 EO or 8 EO, C₁₂₋₁₈ alcohols having 3 EO, 5 EO or 7 BO and mixtures thereof, such as mixtures of C₁₂₋₁₄ alcohol having 3 EO and C₁₂₋₁₈ alcohol having 7 EO. The specified degrees of ethoxylation are statistical averages which for an individual product can be a whole number or a fraction. Preferred alcohol ethoxylates have a narrow homolog distribution (narrow range ethoxylates, NRE). In addition to these non-ionic surfactants, fatty alcohols having more than 12 EO can also be used. Examples include tallow fatty alcohol having 14 EO, EO, 30 EO or 40 EO. Non-ionic surfactants containing EO and PO groups together in the molecule can also be used according to the invention. Block copolymers having EO-PO block units or PO-EO block units can be used here, as too can EO-PO-EO copolymers or PO-EO-PO copolymers. Mixed alkoxylated non-ionic surfactants, in which EO and PO units are distributed randomly rather than in blocks, can also be used of course. Such products are obtainable by the simultaneous action of ethylene oxide and propylene oxide on fatty alcohols.

Alkyl glucosides according to the general formula RO(G)ₓ can also be used as non-ionic surfactants, wherein R is a primary straight-chain or methyl-branched aliphatic residue, in particular, one methyl-branched in the 2-position, having 8 to 22, preferably 12 to 18 C atoms, and G is a glycoside unit having 5 or 6 C atoms, preferably glucose. The degree of oligomerization x, which indicates the distribution of monoglycosides and oligoglycosides, is any number from 1 to 10; x is preferably from 1.2 to 1.4. Alkyl glucosides are known, mild surfactants.

Another class of preferred non-ionic surfactants, which are used either as the only non-ionic surfactant or in combination with other non-ionic surfactants, are alkoxylated, preferably ethoxylated or ethoxylated and propoxylated, fatty acid alkyl esters, preferably having 1 to 4 carbon atoms in the alkyl chain, in particular fatty acid methyl ester.

Amine oxide non-ionic surfactants, for example, N-cocoalkyl-N,N-dimethyl amine oxide and N-tallow alkyl-N,N-dihydroxyethyl amine oxide, and fatty acid alkanol amide non-ionic surfactants can also be used. Further suitable surfactants are polyhydroxy fatty acid amides.

The amount of non-ionic surfactants in the active-agent-containing gel is preferably 5 to 90 wt. %, by preference 7 to 80 wt. % and in particular 9 to 70 wt. %, based on total weight of the active-agent-containing gel.

The active-agent-containing gel can also contain anionic surfactants as the active agent. These include sulfonate and sulfate type anionic surfactants. Suitable surfactants of the sulfonate type are preferably C₉₋₁₃ alkylbenzene sulfonates, olefin sulfonates (i.e., mixtures of alkene and hydroxyalkane sulfonates), and disulfonates, such as are obtained for example from C₁₂₋₁₈ monoolefins having a terminal or internal double bond by sulfonation with gaseous sulfur trioxide and subsequent alkaline or acid hydrolysis of the sulfonation products. Also suitable are alkane sulfonates obtained from C₁₂₋₁₈ alkanes, for example by sulfochlorination or sulfoxidation with subsequent hydrolysis or neutralization. Likewise suitable are esters of a-sulfo fatty acids (ester sulfonates), for example, a-sulfonated methyl esters of hydrogenated coconut, palm kernel or tallow fatty acids.

Other suitable anionic surfactants include sulfonated fatty acid glycerol esters. Fatty acid glycerol esters include mono-, di- and triesters and mixtures thereof, as obtained by esterification of a monoglycerol having 1 to 3 mol of fatty acid or interesterification of triglycerides having 0.3 to 2 mol of glycerol. Preferred sulfonated fatty acid glycerol esters include the sulfonation products of saturated fatty acids having 6 to 22 carbon atoms (e.g., hexanoic acid, octanoic acid, decanoic acid, myristic acid, lauric acid, palmitic acid, stearic acid or docosanoic acid).

Alkali and, in particular, the sodium salts of sulfuric acid semi-esters of C₁₂-C₁₈ fatty alcohols (e.g., coconut fatty alcohol, tallow fatty alcohol, lauryl, myristyl, cetyl or stearyl alcohol), or of C₁₀-C₂₀ oxoalcohols and the semi-esters of secondary alcohols having these chain lengths are preferred as alk(en)yl sulfates. Also preferred are alk(en)yl sulfates of the specified chain length containing a synthetic, straight-chain alkyl residue produced on a petrochemical basis, which have an analogous decomposition behavior to the appropriate compounds based on fat chemistry raw materials. Of interest from a washing agent perspective are the C₁₂-C₁₆ alkyl sulfates and C₁₂-C₁₅ alkyl sulfates and C₁₄-C₁₅ alkyl sulfates. 2,3-Alkyl sulfates, which can be obtained as commercial products from the Shell Oil Company under the name DAN®, are also suitable anionic surfactants.

Sulfuric acid monoesters of the straight-chain or branched C₁₋₂₁ alcohols ethoxylated with 1 to 6 mol of ethylene oxide, such as 2-methyl-branched C₉₋₁₁ alcohols having on average 3.5 mol of ethylene oxide (EO) or C₁₂₋₁₈ fatty alcohols having 1 to 4 EO, are also suitable.

Other suitable anionic surfactants are the salts of alkyl sulfosuccinic acid, also known as sulfosuccinates or sulfosuccinic acid esters, and the monoesters and/or diesters of sulfosuccinic acid with alcohols, preferably fatty alcohols, and in particular ethoxylated fatty alcohols. Preferred sulfosuccinates contain C₈₋₁₈ fatty alcohol residues or mixtures thereof. Particularly preferred sulfosuccinates contain a fatty alcohol residue derived from ethoxylated fatty alcohols which are non-ionic surfactants in their own right (see below for a description). Once again, sulfosuccinates whose fatty alcohol residues derive from ethoxylated fatty alcohols having a narrow homolog distribution are particularly preferred. It is likewise possible to use alk(en)yl succinic acid having preferably 8 to 18 carbon atoms in the alk(en)yl chain or salts thereof.

Particularly preferred anionic surfactants are soaps. Saturated and unsaturated fatty acid soaps are suitable, such as the salts of lauric acid, myristic acid, palmitic acid, stearic acid, (hydrogenated) erucic acid and docosanoic acid, and in particular soap mixtures derived from natural fatty acids (e.g., coconut, palm kernel, olive oil or tallow fatty acids).

Anionic surfactants including the soaps can be present in the form of their ammonium, sodium, potassium or magnesium salts. Anionic surfactants are preferably in the form of their sodium salts. A further preferred counterion for anionic surfactants is choline.

The amount of anionic surfactants in the active-agent-containing gel can be up to 90 wt. %, based on total weight of the active-agent-containing gel.

In another embodiment, the active-agent-containing gel having a surfactant as active agent includes at least one liquid crystalline phase. In this embodiment the gel is produced not by a polymer and gel matrix, but by the surfactant active agent. Gel formation starts as a consequence of the formation of lyotropic, liquid crystalline phases.

Thus, for example, a 40 wt. % solution of C₁₂-C₁₈ ROH with 7 EO (for example, Dehydrol LT 7 from Cognis) or a solution of suitable concentration of sodium dodecyl sulfate or an alkyl ether sulfate forms a cut-resistant gel at room temperature. This active-agent-containing gel can be processed (e.g., mixed with further ingredients) in a heated state and used in the textile pretreatment agent according to the invention.

In addition to or alternatively to surfactants, the active-agent-containing gel can contain bleaching agents, bleach catalysts, enzymes, organic solvents, acids, alkalis, complexing agents and mixtures thereof.

Preferably the active-agent-containing gel contains hydrogen peroxide or a source thereof as bleaching agent.

Sodium perborate tetrahydrate and sodium perborate monohydrate are compounds yielding H₂O₂ with water and which serve as bleaching agents. Other useful bleaching agents include sodium percarbonate, peroxypyrophosphates, citrate perhydrates and H₂O₂-yielding peracidic salts or organic peracids, such as perbenzoates, peroxophthalates, diperazelaic acid, diperdodecanedioic acid, 4-phthalimidoperoxobutanoic acid, 5-phthalimidoperoxopentanoic acid, 6-phthalimidoperoxohexanoic acid, 7-phthalimidoperoxoheptanoic acid, N,N′-terephthaloyl-di-6-aminoperoxohexanoic acid and mixtures thereof. Preferred peracids include the phthalimidoperoxoalkanoic acids, in particular 6-phthalimidoperoxohexanoic acid (PAP). The active-agent-containing gel preferably contains hydrogen peroxide.

The amount of bleaching agent, in particular of hydrogen peroxide, is preferably from 0.01 to 25 wt. %, preferably from 0.1 to 5 wt. %, based on total weight of the active-agent-containing gel.

A further preferred active agent is bleach catalysts, particularly those requiring no further addition of a peroxo compound but whose bleaching action results from activation through atmospheric oxygen. These substances are mostly transition metal salts or transition metal complexes such as Mn, Fe, Co, Ru or Mo salt complexes or carbonyl complexes. Mn, Fe, Co, Ru, Mo, Ti, V and Cu complexes with nitrogen-containing tripod ligands and Co, Fe, Cu and Ru amine complexes can also be used as bleach catalysts.

The active-agent-containing gel can also contain an enzyme or mixture of enzymes. Suitable enzymes include those from the classes of hydrolases, such as proteases, (poly)esterases, lipases or enzymes having a lipolytic action, amylases, cellulases or other glycosyl hydrolases, hemicellulase, cutinases, β-glucanases, oxidases, peroxidases, mannanases, perhydrolases, oxireductases, pectinases and/or laccases. Within the context of the present invention proteases, amylases, lipases, cellulases, mannanases, laccases, tannanases and esterases/polyesterases and mixtures of two or more of these enzymes are preferably used.

Hydrolases contribute in the washing process to the removal of stains such as protein-, fat- or starch-based stains and graying. Cellulases and other glycosyl hydrolases can also contribute to color retention and increased softness of the textile by removing pilling and microfibrils.

Proteases of the subtilisin type, particularly proteases obtained from Bacillus lentus, are preferably used. Enzyme mixtures comprising, for example, protease and amylase or protease and lipase or enzymes having a lipolytic action or protease and cellulase or comprising cellulase and lipase or enzymes having a lipolytic action or comprising protease, amylase and lipase or enzymes having a lipolytic action or protease, lipase or enzymes having a lipolytic action and cellulase, but in particular protease and/or lipase-containing mixtures or mixtures with enzymes having a lipolytic action, are of particular interest. Enzymes having a lipolytic action include the cutinases. Suitable amylases include in particular α-amylases, iso-amylases, pullulanases and pectinases.

The amount of enzyme or enzymes relative to total active-agent-containing gel is 0.01 to 10 wt. %, preferably 0.12 to about 3 wt. %. The enzyme is preferably used as enzyme liquid formulation(s). Most preferred active-agent-containing gels contain protease; amylase; pectinase; mannanase; protease and amylase; protease, amylase and lipase; protease and mannanase; amylase, protease and mannanase; pectinase and mannanase; protease, amylase and pectinase or protease, amylase, lipase and (poly)esterase.

To stabilize the enzymes the active-agent-containing gel can contain stabilizing agents such as boric acid or borates, boric acid derivatives or amino alcohols.

Other preferred active agents in the active-agent-containing gel are organic solvents having a cleaning action. These include in particular hydrocarbons and alkyl ethers.

Suitable hydrocarbons include those having a boiling point above 150° C., preferably above 180° C. Particularly preferred active-agent-containing gels contain paraffins or isoparaffins having a boiling range from 200° C. to 300° C.

Suitable alkyl ethers include dialkyl ethers, particularly C₆-C₁₈ alkyl ethers, more particularly C₈-C₁₂ alkyl ethers such as dioctyl ether. Equally suitable organic solvents which also have an excellent cleaning action are butoxypropoxypropanols (BPP), available commercially as a mixture of several isomers.

Further suitable organic solvents include ethanol, n- or i-propanol, butanols, glycol, propane- or butanediol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol monomethyl or -ethyl ether, diisopropylene glycol monomethyl or -ethyl ether, methoxy, ethoxy or butoxy triglycol, 1-butoxyethoxy-2-propanol, 3-methyl-3-methoxybutanol, propylene glycol-t-butyl ether, di-n-octyl ether and mixtures of these solvents.

The amount of organic solvent in the active-agent-containing gel can be from 0.01 to 50 wt. %, based on total weight of the gel.

Hydrocarbons can be used as an O/W emulsion, particularly an O/W microemulsion. In a preferred embodiment the gel matrix extends into the continuous water phase of the O/W microemulsion while the hydrocarbon is embedded in the inner phase. Use of such an O/W hydrocarbon emulsion is particularly advantageous on oil-based stains.

It can also be advantageous for the active-agent-containing gel to contain a complexing agent. The complexing agent is chosen from those which are stable in the presence of bleach and which stabilize the bleach by complexing metal ions. The amount of complexing agent is conventionally from 0.01 to 1 wt. % based on total weight of the gel. Suitable complexing agents include alkali salts of ethylene diamine tetraacetic acid (EDTA), alkali salts of nitrilotriacetic acid (NTA), methylglycine diacetic acid trisodium salt (MGDA), iminodisuccinates (IDS) or ethylene diamine-N,N′-disuccinate (EDDS). Other suitable complexing agents are organophosphonates such as for example 1-hydroxyethane-1,1-diphosphonic acid (HEDP), aminotri(methylene phosphonic acid) (ATMP), diethylene triamine penta(methylene phosphonic acid) (DTPMP or DETPMP) and 2-phosphonobutane-1,2,4-tricarboxylic acid (PBS-AM), which are mostly used in the form of their ammonium or alkali metal salts. Citric acid, maleic acid or oxalic acid can likewise be used.

The active-agent-containing gel can also contain acids, particularly organic acids, or alkalis as active agents.

In addition to these preferred active agents, the active-agent-containing gel can include further ingredients which improve the action and/or aesthetics of the active-agent-containing gel. These ingredients include humectants, gel breakers, dyes, fragrances, adhesion enhancers and mixtures thereof.

In a preferred embodiment the active-agent-containing gel contains a humectant. Humectants such as glycerol or sorbitol prevent or delay the drying out of the active-agent-containing gel matrix, thereby preventing the gel matrix structure from becoming ineffective. Furthermore, gel breakers improve the penetration of the active agent, particularly surfactants, into treated textile fabric.

Gel breakers such as cumene sulfonate or polyethylene glycols allow production of highly concentrated, surfactant-containing gels which can also be processed very well.

In order to improve the aesthetic impression of the active-agent-containing gel, they can be colored with suitable dyes. Preferred dyes, the selection of which is not difficult to the person skilled in the art, are very stable in storage and have good insensitivity to other ingredients in the active-agent-containing gel and to light, as well as no pronounced substantivity towards textile fibers so as to not color them.

In a preferred embodiment the active-agent-containing gel contains one or more fragrances in an amount of conventionally up to 15 wt. %, preferably 0.01 to 5 wt. %, in particular 0.3 to 3 wt. %, based on total weight of the active-agent-containing gel.

Individual aroma compounds, for example, ester, ether, aldehyde, ketone, alcohol and hydrocarbon synthetic products, can be used as perfume oils or fragrances. Mixtures of different aromas which together generate an attractive fragrance note are preferably used, however. Such perfume oils can also contain natural aroma mixtures such as are accessible from plant sources.

Active-agent-containing gels can also contain an adhesion enhancer, for example, polymers or resins. The adhesion enhancer serves to strengthen adhesion of the active-agent-containing gel to the textile fabric. The polymer and/or resin are preferably at least water-dispersible and more preferably substantially water-soluble. An example of a suitable adhesion enhancer is polyvinyl methyl ether. This is commercially available for example as Lutonal® M 40 from BASF.

To control microorganisms the active-agent-containing gel can contain antimicrobial active agents. A distinction is made here, depending on the antimicrobial spectrum and mechanism of action, between bacteriostatics and bactericides, fungistatics and fungicides, etc. Important substances from these groups include benzalkonium chlorides, alkyl aryl sulfonates, halogen phenols and phenol mercuriacetate, wherein these compounds can also be dispensed with entirely in the washing or cleaning agents according to the invention.

The active-agent-containing gels can contain preservatives, wherein preferably only those having no or only a slight skin-sensitizing potential are used. Examples are sorbic acid and salts thereof, benzoic acid and salts thereof, salicylic acid and salts thereof, phenoxyethanol, formic acid and salts thereof, 3-iodo-2-propynyl butyl carbamate, sodium N-(hydroxymethyl)glycinate, biphenyl-2-ol and mixtures thereof. Other suitable preservatives are isothiazolones, mixtures of isothiazolones and mixtures of isothiazolones with other compounds, for example tetramethylol glycoluril.

To produce the textile pretreatment agent the active-agent-containing gel is preferably positioned between two overhanging, water-insoluble layers. The two water-insoluble layers are joined together at their edges in such a way that they are impervious to water vapor. The active-agent-containing gel sandwiched between the water-insoluble layers is thus largely protected against the penetration of water vapor. The edges of the at least two water-insoluble layers can be joined together, for example, by sealing, welding or gluing.

In a preferred embodiment the textile pretreatment agent has two water-insoluble layers. They can be formed, for example, from two water-insoluble films or from just one water-insoluble film. In the latter case the film is folded in the middle so that three open edges are produced to be joined to the opposing water-insoluble layer.

The water-insoluble films preferably have a suitable imperviousness to water vapor. This can be achieved, for example, with polyolefin film of a suitable thickness. Suitable films include polyethylene and/or polypropylene. The thickness of the water-insoluble films is preferably from 5 to 100 μm.

It can be preferable for water-insoluble films that are used to have a layered structure. In this case the water-insoluble films preferably have at least one layer consisting of a polyolefin.

If the overhanging, opposing edges of the water-insoluble layers are joined together by sealing, the water-insoluble films conveniently have a sealing layer. The sealing layer can be formed by a meltable, sealable material such as polyethylene, or by a sealing paint which responds to heat and/or pressure.

Water-insoluble films can additionally have a barrier layer which not only protects the active-agent-containing gel against penetration of water vapor, but also protects sensitive and/or highly volatile ingredients of the active-agent-containing gel against decomposition and/or evaporation. The barrier layer can consist for example of aluminum, polyvinylidene chloride (PVDC), ethylene vinyl alcohol (EVOH) or a ceramic material such as SiOx. It can have a thickness of 1 to 50 μm.

To increase mechanical stability it can be advantageous for the water-insoluble films to have a stabilizing layer consisting of, for example, a polyester. A typical layered structure of a water-insoluble film would be, for example, 12 μm polyethylene terephthalate/20 μm aluminum/50 μm PE, the PE layer being positioned on the side of the layered water-insoluble films facing the active-agent-containing gel.

In one embodiment of the invention, a textile pretreatment agent according to the invention is produced by heating a first water-insoluble film and thermoforming it under vacuum, forming a recess. The active-agent-containing gel is introduced into the recess and then a second water-insoluble film is fixed on top by sealing. This embodiment is particularly suitable for use with active-agent-containing gels which have not yet reached their final strength after production.

The active-agent-containing gel is applied to a stain by peeling apart the two water-insoluble layers that are joined together. To make this easier for the user, a pull tab or a notch can be provided on the textile pretreatment agent. A further possibility is to hollow out defined zones of the water-insoluble layers during sealing, welding or gluing.

If the two water-insoluble layers are formed from one water-insoluble film, the user can simply unfold the two layers that are joined together and place the side having the active-agent-containing gel on the stain.

If the two water-insoluble layers have been formed from several, particularly preferably two, water-insoluble films, the user peels the two water-insoluble films apart completely. Even if two identical water-insoluble films are used, slight inhomogeneities on the surfaces of the water-insoluble films can cause the active-agent-containing gel to adhere more strongly to one of the two water-insoluble films. In this case it is a statistical question as to which of the two water-insoluble films retains the active-agent-containing gel. In this embodiment, however, it is essential that the active-agent-containing gel has a minimum strength and does not split when the two water-insoluble films are peeled apart. In a preferred execution of the embodiment of the textile treatment agent in which the at least two water-insoluble layers are formed by two water-insoluble films, the two water-insoluble films are different. It is preferable for the surfaces facing the active-agent-containing gel of the two water-insoluble layers to be at least partially different. This difference brings about a stronger adhesion of the active-agent-containing gel to one of the two water-insoluble films.

The difference in strong adhesion can be achieved by various methods. For instance, by applying an adhesive layer to the surface facing the active-agent-containing gel of one water-insoluble film, the adhesion of the active-agent-containing gel to this water-insoluble film can be increased. An acrylate dispersion, for example, can be applied as the adhesive layer. The adhesion of the active-agent-containing gel can also be achieved by modifying the surface facing the active-agent-containing gel of a water-insoluble film by means of plasma treatment, flame treatment and/or corona treatment. In this case the wetting and hence the adhesion of the active-agent-containing gel on the surface of the treated water-insoluble film is increased.

By applying a layer which repels the active-agent-containing gel, adhesion of the active-agent-containing gel to this water-insoluble film can be reduced. After the water-insoluble layers are peeled apart the active-agent-containing gel remains on the uncoated, water-insoluble film.

After peeling apart the water-insoluble layers, one water-insoluble layer remains with the active-agent-containing gel. Using the water-insoluble layer the active-agent-containing gel is brought into direct contact with a stain on a textile fabric. A light contact pressure or a small lateral movement can be used to this end as it is pressed down by the user.

As the active-agent-containing gel adheres more strongly to the textile fabric than to the water-insoluble layer, for example because of the roughness and absorbency of the textile fabric or through the adhesives introduced into the active-agent-containing gel, the water-insoluble layer can be peeled off in such a way that the active-agent-containing gel remains on the stained textile fabric. The stained textile fabric can be placed in a container for storing dirty laundry and stored there until it is washed. During the storage of the stained textile fabric the active agent penetrates into the textile fabric and thus brings about a removal, minimization and/or partial dissolution of the stain. The active agent of the active-agent-containing gel is preferably a surfactant, more preferably a liquid, non-ionic surfactant.

Textile pretreatment agents according to the invention can be used for the removal, minimization and/or partial dissolution of stains on a textile fabric.

### EXAMPLE 1

A clear solution consisting of 63 wt. % demineralized water, 23 wt. % C₁₂-C₁₈ ROH having 7 EO and 14 wt. % C₁₂-C₁₄ ROH having 5 EO and 4 PO was prepared. 1 g of sodium alginate was added to this solution, causing a viscous solution to form. A water-soluble dye and a fragrance blend were added to the solution that was formed.

A water-insoluble film having a layered structure consisting of 20 ™ polyethylene (sealing layer)/10 ™ aluminum/20 μm oriented polypropylene was thermoformed under vacuum at 100 mbar and 210° C. with a retention time of 3 seconds. The dimensions of the recess that was formed were 30×20×3 mm. The recess was three-quarters filled with the solution prepared above and then covered with a layer of an aqueous solution of 3 wt. % CaCl₂x2H₂O. Then a second water-insoluble film having a layered structure consisting of 20 ™ oriented polypropylene/10 μm aluminum/20 μm polyethylene (sealing layer) was fixed on top by sealing.

### EXAMPLE 2

A solution 1, comprising 2 wt. % sodium alginate in demineralized water, and a solution 2, comprising 36 wt. % 1,2-propylene glycol, 11 wt. % C₁₂-C₁₄ ROH having 5 EO and 4 PO, 53 wt. % C₁₂-C₁₈ ROH having 7 EO, were prepared. 2.13 wt. %, relative to the entire solution 2, of sodium citrate were added to this solution and dispersed.

53 parts of solution 1 were mixed with 47 parts of solution 2 in a mixing nozzle and metered into recesses of water-insoluble films (produced as described in Example 1). After 10 minutes an active-agent-containing gel was obtained.

A textile pretreatment agent prepared in accordance with Example 1 was assessed for its effectiveness in pretreating stains. The assessment was performed on the following, synthetic test stains—
10GM: Used engine oil on cotton, wfk-Testgewebe GmbH
20LS2: Lipstick on polyester/cotton, wfk-Testgewebe GmbH

The two water-insoluble films of the textile pretreatment agent according to Example 1 were peeled apart, wherein the active-agent-containing gel adhered completely to one of the two water-insoluble films. The active-agent-containing gel was positioned by means of the adhering water-insoluble film onto the test stains and left on the fabrics overnight (exposure time: approx. 12 hours). Then the test fabrics were washed in a washing machine using the standard 40° C. program (2 commercially available Persil tabs as washing agent, 3.5 kg load), without removing the active-agent-containing gels on the fabrics. A test fabric without pretreatment was washed at the same time as a reference in each case.

The test fabrics were measured before and after washing, by spectral photometric remission measurements in the L-a-b system to obtain the brightness value L (in %). The remission measurements were performed at 3 randomly chosen points on each fabric, with 3 measurements being taken at each measuring point. Before performing the measurements after the washing process all three fabric cloths were ironed and dried under identical conditions. From the 9 measured values per measurement obtained in this way an average L value before washing and an average L value after washing were obtained. The differential ΔL (L value after−L value before) was determined from the difference between these values—

| | ΔL (used engine oil | ΔL (lipstick on |
|---|---|---|
| | on cotton) | polyester/cotton) |
| with pretreatment | 6.94% | 18.04% |
| without pretreatment | 1.37% | 16.17% |

The values obtained clearly show that an improved stain removal is achieved by treatment with the textile pretreatment agent.

Visually, a noticeable lightening could be detected in the areas of the two test fabrics on which the active-agent-containing gel had been placed as compared with the surrounding, untreated fabric. After the washing process the active-agent-containing gels had each dissolved without residue in the washing liquor.

We claim:

1. Textile pretreatment agent comprising:
at least two water-insoluble layers,
an active-agent-containing gel between the at least two water-insoluble layers,
wherein the water-insoluble layers are joined together at their edges so that the active-agent-containing gel is at least partially protected against penetration and/or escape of water vapor, and
wherein the active-agent-containing gel adheres more strongly to a textile fabric than to the at least two water-insoluble layers.

2. Textile pretreatment agent according to claim 1, wherein the at least two water-insoluble layers are comprised of at least two water-insoluble films.

3. Textile pretreatment agent according to claim 2, wherein the at least two water-insoluble films surrounding the active-agent-containing gel differ from each other.

4. Textile pretreatment agent according to claim 3, wherein the active-agent-containing gel adheres more strongly to a first water-insoluble film than to a second water-insoluble film.

5. Textile pretreatment agent according to claim 3, wherein a surface of at least one water-insoluble film facing the active-agent-containing gel has been at least partially modified by application of an adhesive layer, application of a layer which repels the active-agent-containing gel, plasma treatment, flame treatment and/or corona treatment.

6. Textile pretreatment agent according to claim 1, wherein the at least two water-insoluble layers are formed from one water-insoluble film.

7. Textile pretreatment agent according to claim 1, wherein at least one water-insoluble layer includes a recess.

8. Textile pretreatment agent according to claim 1, wherein the active-agent-containing gel has a water-soluble or water-dispersible gel matrix.

9. Textile pretreatment agent according to claim 1, the active-agent-containing gel further comprising a crosslinked polymer, a liquid crystalline phase, inorganic particles or mixtures thereof for forming the gel matrix.

10. Textile pretreatment agent according to claim 1, the active-agent-containing gel further comprising an active agent chosen from surfactants, bleaching agents, bleach catalysts, enzymes, organic solvents, acids, alkalis, complexing agents and mixtures thereof.

11. Textile pretreatment agent according to claim 1, the active-agent-containing gel further comprising a surfactant and/or hydrogen peroxide or a source of hydrogen peroxide.

12. Textile pretreatment agent according to claim 1, the active-agent-containing gel further comprising an ingredient chosen from humectants, gel breakers, dyes, fragrances, adhesion enhancers and mixtures thereof.

13. Method for producing a textile pretreatment agent comprising:
forming at least two water-insoluble layers,
positioning an active-agent-containing gel between the at least two water-insoluble layers,
wherein the active-agent-containing gel adheres more strongly to a textile fabric than to the water-insoluble layers, and
joining the water-insoluble layers together at their edges so that the active-agent-containing gel is at least partially protected against penetration and/or escape of water vapor.

15. Method according to claim 14 further comprising:
separating the at least two water-insoluble layers,
applying the active-agent-containing gel to a fabric stain on a textile, and
washing the textile treated with the active-agent-containing gel,
wherein the active-agent-containing gel removes, minimizes and/or partial dissolves stains on a textile fabric.

16. Method according to claim 15 further comprising allowing the active-agent-containing gel to be exposed to the stain for a time period of 30 seconds or greater prior to washing the textile.

17. Method according to claim 15 further comprising applying the active-agent-containing gel to the fabric stain by using one of the at least two water-insoluble layers to bring the active-agent-containing gel into contact with the stain on the textile fabric, and applying pressure or lateral movement when contacting the stain with the gel.
